(19) United States
(12) Patent Application Publication
(10) Pub. No.: US 2004/0058846 A1
(43) Pub. Date: Mar. 25, 2004

(54) Copolymers that prevent glass from corroding

(76) Inventors: Axel Kistenmacher, Bad Durkheim (DE); Stephan Nied, Hanhofen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,771

(22) PCT Filed: Jan. 25, 2002
(86) PCT No.: PCT/EP02/00836

(30) Foreign Application Priority Data
Feb. 1, 2001 (DE) 10104469.0

(51) Int. Cl. C11D 3/37

(52) U.S. Cl. 510/475

(57) ABSTRACT

The invention relates to the use of copolymers in cleaner formulations for preventing glass from corroding when cleaned in a dishwasher. The copolymers contain: a) 20 to 70% by weight of at least one monomer component (A) from the group of the monoethylenically unsaturated C₃-C₁₀ mono- and dicarboxylic acids or the anhydrides thereof; b) 30 to 80% by weight of at least one monomer component (B) of the general formula (I), wherein R¹, R² and R³ independently represent H, CH₃, C₂H₅, C₃H₇, COOH or OH, Y represents —C(═O)—, —C(═O)—O—, —O—, —O—C(═O)—, —O—C(═O)—O— or —C(═O)—NH—, n equals 0 or 1, R⁴ is either an aromatic or a linear, branched or cyclic aliphatic group with 1 to 6 carbon atoms, and R² and R⁴ optionally form together an alkyl moiety with 3 to 6 carbon atoms, which can be optionally substituted by C₁-C₃ alkyl groups, thereby forming a cycle; c) 0 to 25% by weight of at least one further monomer component (C) that can be copolymerized with the monomer components (A) and (B) and that is selected from the group consisting of α olefins with 10 or more carbon atoms, polyisobutenes with an average of 12 to 100 carbon atoms, Cₙ-(meth)acrylates wherein n is greater than 6, hydroxy-(meth)acrylates, Cₙ vinylesters or Cₙ vinylethers wherein n is greater than 6, acrylnitriles, acrylamides, vinylformamides, allylalcohols, vinylphosphonates, vinyl-substituted heterocycles and unsaturated organosulfonic acids.

The invention relates to the use of certain copolymers, specified in the text, in detergent formulations for preventing glass corrosion during the cleaning process in (machine) dishwashers.

The cleaning of glasses or other glassware such as plates or bowls in dishwashers causes problems in two respects. First, filming and spotting is observed on the glassware, caused in particular by incomplete removal of fatty or oily food residues from the glass articles in question during dishwashing. Said filming and spotting may occur after each washing operation at different sites on the washed glass articles. Since it is a reversible process, the filming and spotting can be removed from the glass articles affected with relative ease—for example, manually using a dishcloth.

The second unwanted side effect of the washing of glass articles in dishwashers is the glass corrosion which occurs in particular after repeated washing. Unlike the filming and spotting, glass corrosion is an irreversible process. Areas of glass articles, once affected by glass corrosion, can no longer be returned to their original condition.

Frequent corrosion phenomena include iridescence, clouding and annular clouding, and scoring. The incidence of glass corrosion phenomena is dependent on a multiplicity of parameters, including the type of glass, its processing, the detergent composition and the cleaning temperature. The origin of the macroscopically visible glass corrosion is usually an uneven erosion of the silicate network. In the case of detergent compositions with a high disilicate content, however, silicate deposits have also been detected on the glass surface, and likewise lead to visually perceptible clouding. The problem of glass corrosion is described in detail in the literature (for example, in W. Buchmeier et al., SÖFW-Journal 122 (1996) p. 398 ff.).

EP-A 462 829 describes a chlorine-free detergent composition for use in dishwashers. This composition is suitable for preventing the abovementioned filming and spotting on glasses. Detergent ingredients described as relevant to this purpose comprise copolymers composed of the monomer maleic acid and/or its anhydride or a salt thereof and also at least one polymerizable monomer from the group of alkanes, alkenes, dienes, alkynes or aromatics each having at least four carbon atoms, especially isobutylene, diisobutylene, styrene, decene or eicosene.

Different kinds of detergent compositions are proposed for preventing the glass corrosion phenomenon. WO 99/05 248 describes water-soluble cationic or amphoteric polymers as corrosion inhibitors for use in dishwashers, especially for preventing the corrosion of decorative glass and decorative ceramics. The monomer units used comprise olefins possessing one or more quaternary nitrogen atoms or one or more amine groups.

WO 98/02 515 describes a detergent composition for use in dishwashers which comprises special alkali metal silicates for the purpose of preventing the corrosion of glasses, crystal, and porcelain.

WO 96/36 687 describes a detergent composition which foregoes silicates and uses aluminum(III) compounds as components relevant to preventing glass corrosion. The aluminum(III) compounds feature a specific retarded dissolution behavior.

Experience shows, however, that the problem of glass corrosion during the cleaning process in dishwashers has not been solved satisfactorily to date.

It is an object of the present invention to provide detergent compositions which ensure effective prevention of glassware corrosion in dishwashers even on frequent washing.

We have found that this object is achieved by the use of copolymers comprising

a) from 20 to 70% by weight of at least one monomer unit (A) from the group of monoethylenically unsaturated C₃-C₁₀ monocarboxylic and dicarboxylic acids or their anhydrides,

b) from 30 to 80% by weight of at least one monomer unit (B) of the formula (I)

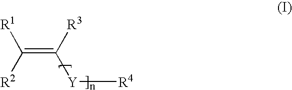

where R¹, R² and R³ independently of one another are H, CH₃, C₂H₅, C₃H₇, COOH or OH,

Y is —C(═O)—, —C(═O)—O—, —O—, —O—C(═O)—, —O—C(═O)—O— or —C(═O)—NH—,

n is 0 or 1,

R⁴ is either an aromatic or a linear, branched or cyclic aliphatic radical having from 1 to 6 carbon atoms,

if desired, R² and R⁴ together form an alkylene unit having from 3 to 6 carbon atoms which is unsubstituted or substituted by C₁-C₃ alkyl groups, and so form a ring,

c) from 0 to 25% by weight of at least one further monomer unit (C), which is copolymerizable with the monomer units (A) and (B) and is from the group consisting of α-olefins having 10 or more carbon atoms, olefin mixtures of α-olefins having 10 or more carbon atoms, polyisobutenes having on average from 12 to 100 carbon atoms, Cₙ (meth)acrylates where n is greater than 6, hydroxy (meth)acrylates, Cₙ vinyl esters or Cₙ vinyl ethers where n is greater than 6, acrylonitriles, acrylamides, vinylformamides, allyl alcohols, vinylphosphonates, vinyl-substituted heterocycles and unsaturated organic sulfonic acids.

The inventive use of these copolymers effectively prevents glass corrosion during the washing operation in dishwashers. Even after a multiplicity of cleaning cycles, the washed glassware shows no iridescence, no clouding or annular clouding, and no scoring. The corrosion prevention effect is observed irrespective of the type of glass and its processing.

The copolymers may be used to clean glassware in machine dishwashers both in the household sector and in the commercial sector. This is not the case with numerous commercial detergent compositions.

It is true that EP-A 462 829 discloses detergent formulations comprising copolymers some of which fall within the above-defined range of the copolymers of the present invention. However, EP-A 462 829 does not disclose any possibility of using the copolymers and detergent formulations it describes to prevent glass corrosion.

The copolymers described above include from 20 to 70% by weight of at least one monomer unit (A) from the group of monoethylenically unsaturated C₃-C₁₀ monocarboxylic and dicarboxylic acids or their anhydrides.

Examples of suitable monomer units (A) include acrylic acid, methacrylic acid, maleic acid, maleic anhydride, fumaric acid, itaconic acid, citraconic acid, methylenemalonic acid, and crotonic acid.

In one preferred embodiment of the present invention, maleic acid, maleic anhydride and/or acrylic acid is used as monomer unit (A).

The copolymers further include from 30 to 80% by weight of at least one monomer unit (B) of the formula (I)

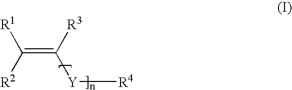

where R¹, R² and R³ independently of one another are H, CH₃, C₂H₅, C₃H₇, COOH or OH,

Y is —C(═O)—, —C(═O)—O—, —O—, —O—C(═O)—, —O—C(═O)—O— or —C(═O)—NH—,

n is 0 or 1,

R⁴ is either an aromatic or a linear, branched or cyclic aliphatic radical having from 1 to 6 carbon atoms,

if desired, R² and R⁴ together form an alkylene unit having from 3 to 6 carbon atoms which is unsubstituted or substituted by C₁-C₃ alkyl groups, and so form a ring.

Examples of suitable monomer units (B) embrace the groups of substances set out below.

C₁-C₆ (Meth)acrylic esters such as methyl acrylate, ethyl acrylate, methyl methacrylate, ethyl methacrylate, butyl (meth)acrylate;

C₂-C₈ olefins such as ethene, propene, butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexene, ethylcyclohexene, 1-octene or technical-grade diisobutene, which includes 2,4,4-trimethyl-1-pentene and 2,4,4-trimethyl-2-pentene; cyclopentene, hexene or technical-grade diisobutene is especially suitable;

styrenes.

The copolymers may include at least one further monomer unit (C) which accounts for from 0 to 25% by weight, based on the overall weight of the copolymer.

Examples of suitable monomer units (C) copolymerizable with the monomer units (A) and (B) include the groups of substances set out below.

α-Olefins having 10 or more carbon atoms, such as 1-decene, 1-dodecene, 1-hexadecene, 1-octadecene and C₂₂ α-olefin, especially 1-dodecene, 1-octadecene or C₂₂ α-olefin;

olefin mixtures of α-olefins having from 10 to 28 carbon atoms, such as C₁₀-C₁₂ α-olefins (α-olefins having 10 or 12 carbon atoms), C₁₂-C₁₄ α-olefins, C₁₄-C₁₈ α-olefins, C₂₀-C₂₄ α-olefins, C₂₄-C₂₈ α-olefins, preferably C₂₀-C₂₄ α-olefins;

olefin mixtures of at least two different α-olefins having 30 or more carbon atoms, such as C₃₀+ α-olefins (olefin mixture of C₃₀ α-olefin and at least one other α-olefin having an even number of carbon atoms greater than 30);

especially polyisobutenes having on average from 12 to 100 carbon atoms and an α-olefin content of more than 80%, such as polyisobutene 1000 (polyisobutene having an average molecular mass of 1000);

Cₙ (meth)acrylates where n is greater than 6, such as ethylhexyl (meth)acrylate, lauryl (meth)acrylate, stearyl (meth)acrylate;

hydroxy (meth)acrylates such as hydroxyethyl (meth)acrylate, hydroxypropyl (meth)acrylate;

alkylpolyethylene glycol (meth)acrylate;

Cₙ vinyl esters or Cₙ vinyl ethers where n is greater than 6, such as dodecenoic acid vinyl esters, stearic acid vinyl ester, dodecyl vinyl ether, octadecyl vinyl ether;

acrylonitriles, acrylamides, vinylformamides, allyl alcohols, vinylphoshonoates;

vinyl-substituted heterocycles such as N-vinylpyrrolidone or N-vinylcaprolactam;

unsaturated organic sulfonic acids such as styrenesulfonic acid, 2-acrylamido-2-methylpropanesulfonic acid, vinylsulfonic acid, methallylsulfonic acid.

The copolymers may be used in the form of the free acid, a salt thereof, or the anhydride or else may be in partly neutralized form. In particular, the copolymers may be present in the form of their sodium, potassium or ammonium salts.

The copolymers may be subjected to an additional reaction. Examples of such reactions are esterifications with C₁-C₂₀ alcohols, alkylpolyalkylene glycols such as methylpolyethylene glycol having an average degree of ethoxylation of 45 or alkylpolyethylene glycol-block-polypropylene glycols such as methylpolyethylene glycol-block-polypropylene glycol having 40 ethylene oxide units and 5 propylene oxide units. This reaction may likewise be carried out with C₁-C₂₀ amines or alkylpolyalkylene glycol amines such as methylpolyethylene glycol amine having an average degree of ethoxylation of 8, with the formation of amide linkages.

The weight-average molecular weight of the copolymers is from 1000 to 200,000, preferably from 2000 to 50,000, with particular preference from 2000 to 20,000. The copolymers are prepared by processes known to the skilled worker.

One preferred embodiment of the present invention uses copolymers comprising maleic acid and/or maleic anhydride as monomer unit (A) and at least one monomer unit (B) from the group consisting of cyclopentene, hexene and technical-grade diisobutene. Particular preference is given to using copolymers comprising maleic anhydride as monomer unit (A) and technical-grade diisobutene as monomer unit (B).

In a further preferred embodiment of the present invention the copolymers are in the form of their alkali metal salt or ammonium salt, with particular preference in the form of their sodium salt or ammonium salt.

Within the detergent formulation the copolymers are present at from 0.01 to 10%, preferably from 0.05 to 5% by weight, with particular preference from 0.1 to 3% by weight, based on the overall weight of the detergent formulation.

The copolymers may be used in the form of their aqueous solutions or dispersions. The copolymers may also be used in solid form, as powders or granules, for example. These are obtainable, for example, by spray drying with possible subsequent compaction or by spray granulation. At the drying stage it is possible to incorporate further water-soluble substances such as sodium sulfate, sodium chloride, sodium acetate, sodium citrate, pentasodium triphosphate, sodium carbonate, sodium hydrogencarbonate or polymers such as polyacrylates, polyacrylic acid, polyvinyl alcohol, Sokalan® CP 5 (copolymer containing polyacrylic acid and maleic acid as monomer units), cellulose and cellulose derivatives, sugars and sugar derivatives in the sense of a cogranulated formulation. It is also possible to incorporate poorly water-soluble or water-insoluble substances or to use them as carrier substances, examples being zeolites and precipitated silicas. Particularly suitable (co)granules are those comprising copolymers and from 10 to 50% by weight of sodium sulfate, sodium carbonate, sodium hydrogen carbonate and/or polyacrylates.

The copolymers may be used inventively in liquid, gel, powder, granular and tablet dishwashing detergents. One possibility is to incorporate the copolymers, alone or together with other formulating ingredients, into particular compartments such as microcapsules or gel capsules. Moreover, the copolymers may also be installed in special compartments within dishwasher detergent tablets, said compartments possibly differing in their dissolution behavior from the other tablet compartments. Said compartments may comprise specific tablet layers or specific shapes let into the tablet, bonded to the tablet, or enveloped by the tablet.

Besides the copolymers described above, the detergent formulation comprises further components that are known to the skilled worker. Examples of these are set out below.

Builders

Both water-soluble and water-insoluble builders may be used, their principal function being to bind calcium and magnesium. Customary builders, which may by present in the detergent formulation at from 10 to 90% by weight, based on the overall preparation, include, for example, phosphates such as alkali metal phosphates and polymeric alkali metal phosphates, which may be present in the form of their alkaline, neutral or acidic sodium or potassium salts.

Examples of these include trisodium phosphate, tetrasodium diphosphate, disodium dihydrogen phosphate, pentasodium tripolyphosphate, the compound known as sodium hexametaphosphate, oligomeric trisodium phosphate with degrees of oligomerization of from 5 to 1000, in particular from 5 to 50, and also the corresponding potassium salts, or mixtures of sodium hexametaphosphate and the corresponding potassium salts, or mixtures of sodium salts and potassium salts. These phosphates are preferably used in the range from 5% by weight to 65% by weight based on the overall formulation and calculated as anhydrous active substance.

The following may also be used as builders:

low molecular mass carboxylic acids and their salts, such as alkali metal citrates, especially anhydrous trisodium citrate or trisodium citrate dihydrate, alkali metal succinates, alkali metal malonates, fatty acid sulfonates, oxydisuccinate, alkyl- or alkenyldisuccinates, gluconic acids, oxadiacetates, carboxymethyloxysuccinates, tartrate monosuccinate, tartrate disuccinate, tartrate monoacetate, tartrate diacetate, and α-hydroxypropionic acid;

oxidized starches and oxidized polysaccharides;

homo- and copolymeric polycarboxylic acids and their salts, such as polyacrylic acid, polymethacrylic acid and copolymers of maleic acid and acrylic acid;

graft polymers of monoethylenically unsaturated monocarboxylic and/or dicarboxylic acids on monosaccharides, oligosaccharides, polysaccharides or polyaspartic acid;

aminopolycarboxylates and polyaspartic acid;

complexing agents and phosphonates and their salts, such as nitrilotriacetic acid, ethylenediaminetetraacetic acid, diethylenetriaminepentaacetic acid, hydroxyethylethylenediaminetriacetic acid, methylglycinediacetic acid, 2-phosphono-1,2,4-butanetricarboxylic acid, aminotri(methylenephosphonic acid), 1-hydroxyethylene(1,1-diphosphonic acid), ethylenediaminetetramethylenephosphonic acid, hexamethylenediaminetetramethylenephosphonic acid or diethylenetriaminepentamethylenephosphonic acid;

silicates such as sodium disilicate and sodium metasilicate;

water-insoluble builders such as zeolites and crystalline phyllosilicates.

The crystalline phyllosilicates correspond in particular to the general formula NaMSiₓO₂ₓ₊₁*y H₂O, where M is sodium or hydrogen, x is a number from 1.9 to 22, preferably from 1.9 to 4, and y is a number from 0 to 33. Known examples include in particular α-Na₂Si₂O₅, β-Na₂Si₂O₅, and δ-Na₂Si₂O₅. Mixtures of the aforementioned builder substances are likewise included here. Preference is given to using trisodium citrate and/or pentasodium tripolyphosphate and/or sodium carbonate and/or sodium bicarbonate and/or gluconates and/or silicatic builders from the class of the disilicates and/or metasilicates.

Alkali Carriers

Further constituents of the detergent formulation that may be present include alkali carriers. Alkali carriers are ammonium and/or alkali metal hydroxides, ammonium and/or alkali metal carbonates, ammonium and/or alkali metal hydrogen carbonates, ammonium and/or alkali metal sesquicarbonates, ammonium and/or alkali metal silicates, ammonium and/or alkali metal metasilicates, and mixtures of the aforementioned substances, preference being given to the use of ammonium and/or alkali metal carbonates, especially sodium carbonate, sodium hydrogen carbonate or sodium sesquicarbonate.

Preferred combinations of builder and alkali carrier are mixtures of tripolyphosphate and sodium carbonate or tripolyphosphate, sodium carbonate, and sodium disilicate.

Surfactants

As further component the detergent formulation preferably includes low-foaming nonionic surfactants in proportions of from 0.1 to 20% by weight, preferably from 0.1 to 10% by weight, with particular preference from 0.25 to 4% by weight.

These are, for example, surfactants from the group of the fatty alcohol alkoxylates of the formula (II), which are available commercially, for example, under the product names Plurafac® (BASF Aktiengesellschaft), especially Plurafac LF 403, or Dehypon® (Cognis).

R²—O—(CH₂—CH₂—O)ₚ—(CHR¹—CH₂—O)ₘ—R³ (II)

where R¹ and R³ independently of one another are CₙH₂ₙ₊₁ and n is from 1 to 4,

R² is CₙH₂ₙ₊₁, and n is from 3 to 30, and

m and p independently of one another are from 0 to 300.

It is also possible to use diblock and multiblock copolymers composed of ethylene oxide and propylene oxide, which are available commercially, for example, under the name Pluronic® (BASF Aktiengesellschaft) or Tetronic® (BASF Corporation). Use may also be made of reaction products of sorbitan esters with ethylene oxide and/or propylene oxide. Likewise suitable are amine oxides or alkyl glycosides. An overview of suitable nonionic surfactants is given by EP-A 851 023 and also DE-A 198 19 187.

The formulation may further comprise anionic or zwitterionic surf-actants, preferably in a blend with nonionic surfactants. Suitable anionic and zwitterionic surfactants are likewise specified in EP-A 851 023 and also DE-A 198 19 187.

Bleaches

Bleaches subdivide into oxygen bleaches and chlorine bleaches. Oxygen bleaches used include alkali metal perborates and their hydrates, and alkali metal percarbonates. Preferred bleaches here are sodium perborate in the form of the monohydrate or tetrahydrate, sodium percarbonate, or the hydrates of sodium percarbonate.

Likewise suitable for use as oxygen bleaches are persulfates and hydrogen peroxide.

Typical oxygen bleaches also include organic peracids such as perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyldiperoxybutane-1,4-dioic acid.

Moreover, the following oxygen bleaches may also find application in the cleaning formulation:

cationic peroxy acids which are described in the patent applications U.S. Pat. No. 5,422,028, U.S. Pat. No. 5,294,362 and U.S. Pat. No. 5,292,447;

sulfonylperoxy acids which are described in the patent application U.S. Pat. No. 5,039,447.

Oxygen bleaches are used in amounts of from 0.5 to 30% by weight, preferably from 1 to 20% by weight, with particular preference from 3 to 15% by weight, based on the overall cleaning formulation.

Chlorine bleaches and also the combination of chlorine bleaches with peroxide bleaches may likewise be used. Examples of known chlorine bleaches include 1,3-dichloro-5,5-dimethylhydantoin, N-chlorosulfamide, chloramine T, dichloramine T, chloramine B, N,N′-dichlorobenzoylurea, dichloro-p-toluenesulfonamide and trichloroethylamine. Preferred chlorine bleaches are sodium hypochlorite, calcium hypochlorite, potassium hypochlorite, magnesium hypochlorite, potassium dichloroisocyanurate or sodium dichloroisocyanurate.

Chlorine bleaches are used in amounts of from 0.1 to 20% by weight, preferably from 0.1 to 10% by weight, with particular preference from 0.3 to 8% by weight, based on the overall cleaning formulation.

It is also possible to add small amounts of bleach stabilizers such as phosphonates, borates, metaborates, metasilicates or magnesium salts, for example.

Bleach Activators

Bleach activators are compounds which under perhydrolysis conditions give aliphatic peroxocarboxylic acids having preferably 1 to 10 carbon atoms, in particular from 2 to 4 carbon atoms, and/or substituted perbenzoic acid. Suitable compounds are those containing one or more N- and/or O-acyl groups and/or substituted or unsubstituted benzoyl groups, such as substances from the class of the anhydrides, esters, imides, acylated imidazoles or oximes. Examples are tetraacetylethylenediamine (TAED), tetraacetylmethylenediamine (TAMD), tetraacetylglycoluril (TAGU), tetraacetylhexylenediamine (TAHD), N-acyl imides, such as N-nonanoylsuccinimide (NOSI), acylated phenolsulfonates, such as n-nonanoyl- or isononanoyloxybenzenesulfonates (n- or iso-NOBS) for example, pentaacetylglucose (PAG), 1,5-diacetyl-2,2-dioxohexahydro-1,3,5-triazine (DADHT) or isatoic anhydride (ISA).

Suitable bleach activators likewise include nitrile quats such as N-methylmorpholiniumacetonitrile salts (MMA salts) or trimethylammoniumacetonitrile salts (TMAQ salts), for example.

Suitable bleach activators preferably include those from the group consisting of polyacylated alkylenediamines, with particular preference TAED, N-acylimides, with particular preference NOSI, acylated phenolsulfonates, with particular preference n- or iso-NOBS, MMA, and TMAQ.

Additionally, the following substances may find application as bleach activators in the cleaning formulation:

carboxylic anhydrides such as phthalic anhydride;

acylated polyhydric alcohols such as triacetin, ethylene glycol diacetate or 2,5-diacetoxy-2,5-dihydrofuran;

the enol esters known from DE-A 196 16 693 and DE-A 196 16 767, and also acetylated sorbitol and mannitol and their mixtures described in EP-A 525 239;

acylated sugar derivatives, especially pentaacetylglucose (PAG), pentaacetylfructose, tetraacetylxylose and octaacetyllactose, and also acetylated, unalkylated or N-alkylated glucamine and gluconolactone, and/or N-acylated lactams, such as N-benzoylcaprolactam, which are known from the documents WO 94/27 970, WO 94/28 102, WO 94/28 103, WO 95/00 626, WO 95/14 759, and WO 95/17 498;

the hydrophilically substituted acyl acetals set out in DE-A 196 16 769, and also the acyl lactams described in DE-A 196 16 770 and WO 95/14 075, may be used in the same way as the combinations of conventional bleach activators known from DE-A 44 43 177.

Bleach activators are used in amounts of from 0.1 to 10% by weight, preferably from 1 to 9% by weight, with particular preference from 1.5 to 8% by weight, based on the overall cleaning formulation.

Bleaching Catalysts

In addition to or instead of the conventional bleach activators listed above, the cleaning formulations of the invention may also include bleach-boosting transition metal salts or transition metal complexes and/or sulfone imines known from EP-A 446 982 and EP-A 453 003, these compounds being known as bleaching catalysts.

The transition metal compounds in question include, for example, the manganese, iron, cobalt, ruthenium or molybdenum salen complexes known from DE-A 195 29 905 and their N-analog compounds known from DE-A 196 20 267; the manganese, iron, cobalt, ruthenium or molybdenum carbonyl complexes known from DE-A 195 36 082; the manganese, iron, cobalt, ruthenium, molybdenum, titanium, vanadium and copper complexes with nitrogenous tripod ligands, described in DE-A 196 05 688; the cobalt, iron, copper and ruthenium ammine complexes known from DE-A 196 20 411; the manganese, copper and cobalt complexes described in DE-A 44 16 438; the cobalt complexes described in EP-A 272 030; the manganese complexes known from EP-A 693 550; the manganese, iron, cobalt and copper complexes known from EP-A 392 592; and/or the manganese complexes described in EP-A 443 651, EP-A 458 397, EP-A 458 398, EP-A 549 271, EP-A 549 272, EP-A 544 490 and EP-A 544519. Combinations of bleach activators and transition metal bleaching catalysts are known, for example, from DE-A 196 13 103 and WO 95/27 775.

Dinuclear manganese complexes containing 1,4,7-trimethyl-1,4,7-triazacyclononane (TMTACN), such as [(TMTACN)₂Mn^{IV}Mn^{IV}(μ-O)₃]²⁺(PF₆⁻)₂, for example, are likewise suitable as effective bleaching catalysts. These manganese complexes are likewise described in the aforementioned documents.

Suitable bleaching catalysts include preferably bleach-boosting transition metal complexes or transition metal salts from the group consisting of the salts and complexes of manganese and the salts and complexes of cobalt. With particular preference they include the cobalt ammine complexes, the cobalt acetato complexes, the cobalt carbonyl complexes, the chlorides of cobalt or manganese, manganese sulfate or [(TMTACN)₂Mn^{IV}Mn^{IV} (μ-O)₃]²⁺(PF₆-)₂.

Corrosion Inhibitors

In particular it is possible to use silver protectants from the group of triazoles, benzotriazoles, bisbenzotriazoles, aminotriazoles, alkylaminotriazoles and transition metal salts or transition metal complexes. Used with particular preference are benzotriazole and/or alkylaminotriazole. Furthermore, it is common in detergent formulations to use active chlorine agents which are able to reduce significantly the corrosion of the silver surface. In chlorine-free cleaning products preference is given to using organic redox-active compounds containing oxygen and nitrogen, such as dihydric and trihydric phenols, e.g., hydroquinone, pyrocatechol, hydroxyhydroquinone, gallic acid, phloroglucinol, pyrogallol, and/or derivatives of these classes of compounds. Additionally, saltlike and complexlike inorganic compounds, such as salts of the metals Mn, Ti, Zr Hf, V, Co and Ce, frequently find application. Preference is given in this context to the transition metal salts selected from the group of manganese and/or cobalt salts and/or manganese and/or cobalt complexes, with particular preference from the group of the cobalt ammine complexes, cobalt acetato complexes, cobalt carbonyl complexes, the chlorides of cobalt or manganese, and manganese sulfate. Zinc compounds or bismuth compounds may similarly be used to prevent corrosion on the ware.

Enzymes

Between 0 and 5% by weight of enzymes, based on the overall preparation, may be added to the cleaning product in order to raise its performance or to ensure cleaning of equal quality under relatively mild conditions. Lipases, amylases, cellulases and proteases are among the enzymes most frequently used. It is also possible, for example, to use esterases, pectinases, lactases and peroxidases.

Examples of preferred proteases are BLAP®140 (Biozym), Optimase® M-440 and Opticlean® M-250 (Solvay Enzymes), Maxacal® CX, Maxapem®, Esperase® (Gist Brocades), Savinase® (Novo) or Purafect OxP (Genencor). Particularly suitable cellulases and lipases are Celluzym® 0,7T and Lipolase® 30T (Novo Nordisk). Amylases used particularly include Duramyl®, Termamyl® 60 T and Termamyl® 90 T (Novo), Amylase-LT® (Solvay Enzymes), Maxamyl® P5000 (Gist Brocades) or Purafect® OxAm (Genencor).

Further Additions

Liquid paraffins and silicone oils may optionally be used as defoamers and to protect plastic and metal surfaces. Defoamers are generally added in proportions of from 0.001% to 5%. Additionally, dyes, perfumes and other fragrances may be added to the cleaning formulation. Detergent formulations in the form of tablets may also contain polyethylene glycol as a tableting auxiliary.

In accordance with the invention, the copolymers may be used in detergent formulations for both the household sector and the commercial sector. Commercial cleaners generally comprise a builder system based on pentasodium triphosphate, and/or sodium citrate and/or complexing agents such as nitrilotriacetate, for example. Unlike household cleaners, they frequently operate with sodium hydroxide or potassium hydroxide as alkali carriers. In addition, the bleaches used frequently include chlorine compounds such as sodium dichloroisocyanurate.

Detergent Formulations (Tables 1-3):

Remarks Relating to Tables 1 to 3:

*sum of amylase and protease, present in a ratio of 1:1.

Abbreviations: R: framework formulation; V: experimental formulation; AS: acrylic acid; MS: maleic acid; VAc: vinyl acetate; SKS 6: Na-SKS-6® (Clariant trademark); Mw: weight-average molecular weight determined by means of gel permeation chromatography; Co-pentammin-Cl: cobalt pentaammine chloride complex, Plurafac®: (BASF Aktiengesellschaft trademark)

all figures are in % by weight.

TABLE 1

| Ingredient | R 1 | V1.1 | V1.2 | V1.3 | V1.4 |
|---|---|---|---|---|---|
| Pentasodium triphosphate | 40-65 | 48 | 42 | 44 | 61 |
| Sodium citrate | 0-10 | — | — | 5 | — |
| Polyacrylic acid Mw 8000 | 0-10 | 1 | — | 5 | — |
| Polyacrylic acid Mw 4000 | 0-10 | — | 2 | — | — |
| Zeolite A | 0-5 | — | — | 2 | 3 |
| Phyllosilicate SKS-6 | 0-10 | — | — | — | 7 |
| Sodium carbonate | 3-40 | 22 | 33 | 3 | 12 |
| Sodium hydrogen carbonate | 0-10 | 2 | — | — | — |
| Sodium disilicate | 1-25 | 5.3 | 4 | 23 | 2 |
| Sodium metasilicatet. | 0-10 | — | — | 2 | — |
| Borax (disodium tetraborate) | 0-5 | 2 | — | — | — |
| Sodium perborate monohydrate | 0-15 | 10 | — | 9 | — |
| Sodium percarbonate | 0-15 | — | 9 | — | 8 |
| TAED | 0-4 | 2 | — | 2.1 | — |
| MMA | 0-3 | — | 1.2 | — | — |
| TMAQ | 0-3 | — | — | — | 1 |
| Co-pentammin-Cl | 0-1 | — | — | — | — |
| Enzymes* | 0.5-6 | 1 | 1 | 1 | 1 |
| Plurafac ® LF 403 | 0.1-10 | 1.5 | 1 | 3 | 1.3 |
| 1-Hydroxyethylene-1,1-diphos- | 0-2 | — | 0.3 | — | 0.5 |
| phonic acid | | | | | |
| Sodium chloride | 0-10 | — | — | — | — |
| Sodium sulfate | 0-10 | — | — | — | — |
| Water | 0-10 | — | — | — | — |
| Benzotriazole | 0-2 | — | 0.3 | 0.2 | — |
| Polyethylene glycol | 0-8 | 4 | 5 | — | 1 |
| Paraffin | 0-5 | — | 1 | — | 1 |
| Perfume | 0-1 | 0.2 | 0.2 | 0.2 | 0.2 |
| Dye | 0-4 | 1 | — | 0.5 | 1 |

TABLE 2

| Ingredient | R 2 | V2.1 | V2.2 | V2.3 | V2.4 |
|---|---|---|---|---|---|
| Pentasodium triphosphate | 15-39 | 39 | 30 | 22 | 28 |
| Sodium citrate | 0-45 | — | — | 45 | — |
| Polyacrylic acid Mw 8000 | 0-10 | 4 | — | 1 | — |
| Polyacrylic acid Mw 4000 | 0-10 | — | 2 | — | — |
| Zeolite A | 0-5 | — | — | — | — |
| Phyllosilicate SKS-6 | 0-5 | — | — | — | — |
| Sodium carbonate | 3-40 | 30 | 35 | 10 | 6 |
| Sodium hydrogen carbonate | 0-10 | — | — | — | — |
| Sodium disilicate | 1-50 | 5 | 2 | 1 | 45 |
| Sodium metasilicate | 0-10 | — | — | — | — |
| Borax (disodium tetraborate) | 0-5 | 0.5 | — | 1 | — |
| Sodium dichloroisocyanurate | 0-5 | — | — | — | 1 |
| Sodium perborate monohydrate | 0-15 | — | — | 10 | — |
| Sodium percarbonate | 0-15 | — | 4 | — | — |
| TAED | 0-4 | — | 1 | 2 | — |
| MMA | 0-3 | — | — | — | — |
| TMAQ | 0-3 | — | — | — | — |
| Co-pentammin-Cl | 0-1 | — | — | — | — |
| Enzymes* | 0.5-6 | 1 | 3 | 1 | 0.5 |
| Plurafac ® LF 403 | 0.1-10 | 1 | 0.5 | 4 | — |
| 1-Hydroxyethylene-1,1-diphos- | 0-2 | — | — | — | — |
| phonic acid | | | | | |
| Sodium chloride | 0-10 | — | 9.5 | — | — |
| Sodium sulfate | 0-10 | 10 | 10 | — | 9.5 |
| Water | 0-10 | 9.3 | 3 | 3 | 10 |
| Benzotriazole | 0-2 | 0.2 | — | — | — |
| Polyethylene glycol | 0-8 | — | — | — | — |
| Paraffin | 0-5 | — | — | — | — |
| Perfume | 0-1 | — | — | — | — |
| Dye | 0-4 | — | — | — | — |

TABLE 3

| Ingredient | R 3 | V3.1 | V3.2 | V3.3 | V3.4 |
|---|---|---|---|---|---|
| Sodium citrate | 10-50 | 18 | 35 | 43 | 50 |
| Pentasodium triphosphate | 0-14 | — | | | |
| Polyacrylic acid Mw 8000 | 0-10 | 3 | — | 5 | 5 |
| Polyacrylic acid Mw 4000 | 0-10 | — | 3 | — | — |
| Zeolite A | 0-5 | — | 5 | — | — |
| Phyllosilicate SKS-6 | 0-5 | — | — | — | — |
| Sodium carbonate | 3-40 | 15 | 3 | 3 | 9 |
| Sodium hydrogen carbonate | 0-25 | — | — | — | 25 |
| Sodium disilicate | 1-50 | 10 | 22 | 32 | — |
| Sodium metasilicate | 0-10 | — | — | — | — |
| Borax (disodium tetraborate) | 0-5 | 1.5 | — | — | — |
| Sodium dichloroisocyanurate | 0-5 | — | — | — | — |
| Sodium perborate monohydrate | 0-15 | 9 | — | 10 | 7 |
| Sodium percarbonate | 0-25 | — | 25 | — | — |
| TAED | 0-4 | 1.5 | — | 2 | — |
| MMA | 0-3 | — | — | — | 1 |
| TMAQ | 0-3 | — | — | — | — |
| Co-pentammin-Cl | 0-1 | — | 0.5 | — | — |
| Enzymes* | 0.5-6 | 1 | 1 | 1 | 1 |
| Plurafac ® LF 403 | 0.1-10 | 1 | 1.5 | 3 | 2 |
| 1-Hydroxyethylene-1,1-diphos- | 0-2 | — | 0.8 | — | — |
| phonic acid | | | | | |
| Sodium chloride | 0-10 | — | — | — | — |
| Sodium sulfate | 0-40 | 34.5 | 3.2 | — | — |
| Water | 0-10 | 5 | — | 1 | — |
| Benzotriazole | 0-2 | 0.2 | — | — | — |
| Polyethylene glycol | 0-8 | — | — | — | — |
| Paraffin | 0-5 | — | — | — | — |
| Perfume | 0-1 | 0.3 | — | — | — |
| Dye | 0-4 | — | — | — | — |

Test Method (Immersion Test):

The test is conducted in a new 51 glass beaker equipped with a magnetic stirrer rod, a metallic grid base insert, a lid, and a contact thermometer. This glass beaker is charged with 4.5 liters of deionized water, 20 g of the corresponding detergent formulation, and a specified amount of x mg of the test polymeric corrosion inhibitor. The mixture is stirred. Subsequently, 2 champagne glasses (Schott Zwiesel, shape No. 5270/77, Order-No. 416964, h=204 mm) and one long-drink glass (Nachtmann-VIVENDI; Art. No. 50/42) are placed in the glass beaker in such a way that the glasses are fully immersed in the liquid. The liquid is heated to a temperature of 75° C. with stirring and the glasses are stored under these conditions for 72 hours. They are then removed and cleaned once using a commercial phosphate-containing detergent in a Miele G 661 SC dishwasher. This is followed by a visual assessment of the glasses. In this assessment, glass scoring (called cord lines) and glass clouding that occurs are evaluated as follows:

Evaluation of cord lines

| Rating | Condition |
|---|---|
| R0 | No cord lines |
| R1 | Slight cord lines in a very few |
| | areas |
| R2 | Some cord lines in some areas |
| R3 | Cord lines in a number of |
| | areas |
| R4 | Pronounced cord lines in |
| | many areas |

Evaluation of glass clouding

| Rating | Condition |
|---|---|
| T0 | No cloudiness |
| T1 | Slight cloudiness in a very |
| | few areas |
| T2 | Haze in some areas |
| T3 | Haze in a number of areas |
| T4 | Pronounced cloudiness over |
| | the entire glass |

Results:
Inventive examples

| | | Amount | | |
|---|---|---|---|---|
| | | of | | |
| | | polymer | | |
| | Formu- | added | Polymeric glass corrosion | |
| Test No. | lation | [mg] | inhibitor | Result |
| Example 1 | V1.1 | 100 | Cop.^{a} MS/DIB (51:49), | R1, T0 |
| | | | Mw 12 000 | |
| Example 2 | V1.1 | 200 | Cop.^{a} MS/DIB (51:49), | R0, T1 |
| | | | Mw 12 000 | |
| Example 3 | V1.1 | 400 | Cop.^{a} MS/DIB (51:49), | R1, T0 |
| | | | Mw 12 000 | |
| Example 4 | V1.3 | 200 | Cop.^{a} MS/hexene (58:42), | R2, T1 |
| | | | Mw 6000 | |
| Example 5 | V2.1 | 200 | Cop.^{a} MS/isobutene (68:32), | R2, T1 |
| | | | Mw 4000 | |
| Example 6 | V2.2 | 200 | Cop.^{a} MS/isobutene (68:32), | R2, T1 |
| | | | Mw 4000 | |
| Example 7 | V2.4 | 400 | Cop.^{a} AS/butyl acrylate | R1, T2 |
| | | | (70:30), | |
| | | | Mw 14000 | |
| Example 8 | V3.1 | 300 | Cop.^{a} MS/styrene (53:47), | R2, T1 |
| | | | Mw 10000 | |
| Example 9 | V3.2 | 200 | Cop.^{a} MS/styrene (53:47), | R2, T1 |
| | | | Mw 10000 | |
| Example 10 | V3.4 | 200 | Cop.^{a} MS-PEG4/DIB (65:35), | R1, T2 |
| | | | Mw 15000 | |

Amounts for the polymeric glass corrosion inhibitor are in % by weight
Abbreviations:
MS: maleic acid;
DIB: technical-grade diisobutene;
AS: acrylic acid;
MS-PEG4: monoester of maleic acid and tetraethylene glycol;
Cop.: copolymer containing the following monomer units;
^{a}: in the form of the Na salt;
Mw: weight-average molecular weight

Comparative Examples:

| | | Amount | | |
|---|---|---|---|---|
| | | of | | |
| | | polymer | | |
| | Formu- | added | | |
| Test No. | lation | [mg] | Polymer | Results |
| Example 11 | V1.1 | — | — | R3, T2 |
| Example 12 | V1.3 | — | — | R3, T4 |
| Example 13 | V2.1 | — | — | R3, T2 |
| Example 14 | V2.2 | — | — | R3, T2 |
| Example 15 | V2.4 | — | — | R2, T4 |
| Example 16 | V3.1 | — | — | R4, T1 |
| Example 17 | V3.2 | — | — | R3, T2 |
| Example 18 | V3.4 | — | — | R2, T3 |
| Example 19 | V2.2 | 200 | Polyethylene imine Mw | R-*, T4 |
| | | | 20000 | |
| Example 20 | V2.2 | 300 | Terpolymer^{a} | R-*, T4 |
| | | | diallyldimethylammonium | |
| | | | chloride/acrylic | |
| | | | acid/hydroxypropyl acrylate | |
| | | | (35:50:15) Mw 100000 | |
| Example 21 | V1.1 | 400 | Polyvinylpyrrolidone Mw | R2, |
| | | | 40000 | T3** |
| Example 22 | V3.1 | 300 | Cop.^{a} MS/C18 olefin (31:69) | R3, T2 |
| | | | Mw 15000 | |
| Example 23 | V1.3 | 400 | Cop.^{a} AS/2-EHA (70:30) | R3, T3 |
| | | | Mw 60000 | |
| Example 24 | V3.4 | 200 | Cop.^{a} MAS/Stearyl acrylate | R-*, T4 |
| | | | (80:20) | |
| | | | Mw 20000 | |

*Impossible to measure, owing to severe cloudiness
**Yellowish iridescent layer
Abbreviations:
2-EHA: 2-ethylhexyl acrylate;
MAS: methacrylic acid;
Cop: copolymer containing the following monomer units;
^{a}: in the form of the NA salt;
Mw: weight-average molecular weight
Amounts for the polymer are in % by weight

In contrast to the Comparative Examples (11-24), a significant reduction in the glass corrosion of all the glass articles investigated is observed in all of the Examples (1-10) where the copolymers are used in accordance with the invention.

We claim:

1. The use of copolymers comprising
a) from 20 to 70% by weight of at least one monomer unit (A) from the group of monoethylenically unsaturated C₃-C₁₀ monocarboxylic and dicarboxylic acids or their anhydrides, the monomer unit (A) preferably being maleic acid, maleic anhydride and/or acrylic acid,
b) from 30 to 80% by weight of at least one monomer unit (B) of the formula (I) 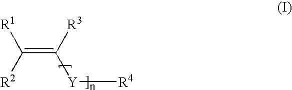
where R¹, R² and R³ independently of one another are H, CH₃, C₂H₅, C₃H₇, COOH or OH,
Y is —C(═O)—, —C(═O)O—, —O—, —O—C(═O)—, —O—C(═O)—O— or —C(═O)—NH—,
n is 0 or 1,
R⁴ is either an aromatic or a linear, branched or cyclic aliphatic radical having from 1 to 6 carbon atoms,
if desired, R² and R⁴ together form an alkylene unit having from 3 to 6 carbon atoms which is unsubstituted or substituted by C₁-C₃ alkyl groups, and so form a ring,
the monomer unit (B) preferably being cyclopentene, hexene and/or technical-grade diisobutene, and
c) from 0 to 25% by weight of at least one further monomer unit (C), which is copolymerizable with the monomer units (A) and (B) and is from the group consisting of α-olefins having 10 or more carbon atoms, olefin mixtures of α-olefins having 10 or more carbon atoms, reactive polyisobutenes having on average from 12 to 100 carbon atoms, Cₙ (meth)acrylates where n>6, hydroxy (meth)acrylates, Cₙ vinyl esters or Cₙ vinyl ethers where n>6, acrylonitriles, acrylamides, vinylformamides, allyl alcohols, vinylphosphonates, vinyl-substituted heterocycles and unsaturated organic sulfonic acids,
the monomer unit (C) preferably being 1-dodecene, 1-octadecene, C₂₂ α-olefin, polyisobutene 1000 and/or an olefin mixture of C₂₀-C₂₄ α-olefins,
in detergent formulations for preventing glass corrosion during the cleaning process in machine dishwashers.

2. The use as claimed in claim 1, wherein the copolymers are used in the form of the free acid, a salt thereof or the anhydride, especially in the form of the sodium salt or ammonium salt.

3. The use as claimed in claim 1 or 2, wherein the copolymers comprise maleic anhydride and technical-grade diisobutene as monomer units and are in the form of the sodium salt.

4. The use as claimed in any of claims 1 to 3, wherein the weight-average molecular weight of the copolymers is from 1000 to 200,000, preferably from 2000 to 50,000, with particular preference from 2000 to 20,000.

5. The use as claimed in any of claims 1 to 4, wherein the copolymers are additionally reacted with alcohols or amines, with the formation of ester or amide linkages respectively.

6. The use as claimed in any of claims 1 to 5, wherein the copolymers are present at from 0.01 to 10% by weight, preferably from 0.05 to 5% by weight, with particular preference from 0.1 to 3% by weight, in a detergent formulation.

7. The use as claimed in any of claims 1 to 6, wherein the copolymers are used in the form of aqueous solutions or aqueous dispersions, in solid form as powders or granules, or in the form of microcapsules or gel capsules in the detergent formulation.

8. The use as claimed in claim 7, wherein the granules comprise the copolymers and from 10 to 50% by weight of sodium sulfate, sodium carbonate, sodium hydrogen carbonate and/or polyacrylates.

9. The use as claimed in claim 7 or 8, wherein the copolymers are incorporated in certain compartments of the detergent formulation, and in the case of detergent formulations in tablet form the compartments are, in particular, tablet layers and/or shapes let into the tablet, bonded to the tablet or enveloped by the tablet.
